(19) United States
(12) Patent Application Publication
(10) Pub. No.: US 2013/0201333 A1
(43) Pub. Date: Aug. 8, 2013

(54) IMAGE-MONITORING DEVICE AND METHOD FOR SSEARCHING FOR OBJECTS THEREFOR

(71) Applicants: Hyounghwa Yoon, Seoul (KR); Youngkyung Park, Seoul (KR); Jaeshin Yu, Uiwang (KR); Sungjin Kim, Anyang (KR)

(72) Inventors: Hyounghwa Yoon, Seoul (KR); Youngkyung Park, Seoul (KR); Jaeshin Yu, Uiwang (KR); Sungjin Kim, Anyang (KR)

(73) Assignee: LG ELECTRONICS INC., Seoul (KR)

(21) Appl. No.: 13/878,554

(22) PCT Filed: Oct. 11, 2010
(86) PCT No.: PCT/KR2010/006929

§ 371 Date: Apr. 9, 2013

(51) Int. Cl. H04N 7/18

(52) U.S. Cl. CPC H04N 7/18
USPC 348/143

(57) ABSTRACT

Disclosed are an image monitoring device capable of searching an object on the basis of a statistical model with respect to the characteristics of an object detected from a monitored image to thereby provide an object search function resistant to a variation in the characteristics of an object according to a monitoring environment, and a method for searching an object thereof. The method for searching an object by an image monitoring device, including: displaying a characteristic value of an object detected from a monitored image and a detection frequency of an object having the characteristic value on a first region; searching a frame, in which an object having a characteristic value selected from characteristic values displayed on the first region is detected, from the monitored image; and displaying the searched frame in a second region.

### TECHNICAL FIELD

The present invention relates to an image monitoring device and a method for searching an object of an image detecting device, and more particularly, to an image monitoring device for searching an object detected from a monitored image and a method for searching an object in such an image monitoring device.

### BACKGROUND ART

In general, various monitoring methods and various monitoring devices have been used for security, or the like. One of the monitoring devices is a monitoring system for monitoring and analyzing a monitored image obtained through a monitoring camera. In a monitoring system, a monitoring camera is installed in the vicinity of a monitoring area and an image obtained through the monitoring camera is provided to a user so that the user may easily recognize whether a particular object is detected from the monitored image.

### DISCLOSURE

### Technical Problem

Therefore, an object of the present invention is to provide an image monitoring device capable of searching an object on the basis of a statistical model with respect to the characteristics of an object detected from a monitored image to thereby provide an object search function resistant to a variation in the characteristics of an object according to a monitored environment, and a method for searching an object thereof.

### Technical Solution

According to an aspect of the present invention, there is provided a method for searching an object by an image monitoring device, including: displaying a characteristic value of an object detected from a monitored image and a detection frequency of the object having the characteristic value on a first region; searching a frame, in which an object having a characteristic value selected from characteristic values displayed on the first region is detected, from the monitored image; and displaying the searched frame in a second region.

In an embodiment of the present invention, the method may further include: inputting a characteristic value of an object to be searched from the monitored image, before the displaying of the characteristic value and the detection frequency on the first region, wherein in the displaying of the characteristic value and the detection frequency on the first region, a detection frequency of the object having the input characteristic value may be distinguishably displayed on the first region.

Also, in an embodiment of the present invention, the method may further include: inputting information regarding a time for searching from the monitored image, before the displaying of the characteristic value and the detection frequency on the first region, wherein in the displaying of the characteristic value and the detection frequency on the first region, the detection frequency of the object having the input characteristic value may be distinguishably displayed on the first region on the basis of the input time information.

Also, in an embodiment of the present invention, the method may further include: inputting information regarding a region to be searched from the monitored image, before the displaying of the characteristic value and the detection frequency on the first region, wherein in the displaying of the characteristic value and the detection frequency on the first region, the detection frequency of the object having the input characteristic value may be distinguishably displayed on the first region on the basis of the input region information.

Also, in an embodiment of the present invention, the input characteristic value may include a first characteristic value and a second characteristic value of the object to be searched from the monitored image, wherein in the displaying of the characteristic value and the detection frequency on the first region, the detection frequency of the object having a value between the first characteristic value and the second characteristic value may be distinguishably displayed on the first region.

Also, in an embodiment of the present invention, the method may further include: displaying the monitored image in a third region, before the inputting of the characteristic value, wherein the inputting of the characteristic value may include calculating a characteristic value of an object selected from objects detected in the third region.

Also, in an embodiment of the present invention, the method may further include: storing the detection frequency with respect to the characteristic value of the object detected from the monitored image, before the displaying of the characteristic value and the detection frequency on the first region.

Also, in an embodiment of the present invention, the method may further include: determining the number of times of detecting the object having the characteristic value from the monitored image; and generating the detection frequency by normalizing the determined number of times of detection.

Also, in an embodiment of the present invention, the characteristic value may include at least one of a size, a velocity, and a color of the object detected from the monitored image.

Also, in an embodiment of the present invention, in the displaying of the characteristic value and the detection frequency on the first region, the characteristic value and the detection frequency may be displayed as a graph on the first region.

Also, in an embodiment of the present invention, the displaying of the searched frame on the second region may be displaying a frame selected from the searched frames.

Also, in an embodiment of the present invention, the frame displayed on the second region may be a thumbnail image.

Also, in an embodiment of the present invention, the method may further include: displaying an image in relation to a thumbnail image selected from the thumbnail images.

According to another aspect of the present invention, there is provided an image monitoring device including: an output unit configured to display a characteristic value of an object detected from a monitored image and a detection frequency of the object having the characteristic value on a first region; and a controller configured to search a frame, in which an object having a characteristic value selected from among characteristic values displayed on the first region is detected, from the monitored image, wherein the output unit may display the searched frame in a second region.

The image monitoring device may further include an input unit configured to receive the characteristic value of the object to be searched from the monitored image, wherein the output unit may distinguishably display a detection frequency of the object having the input characteristic value on the first region.

### Advantageous Effects

According to embodiments of the present invention, a user can effectively filter the characteristics of an object desired to be searched on the basis of statistical data with respect to the characteristics of an object detected from a monitored image. Thus, accuracy in searching an interested object can be enhanced, and thus, a user can easily perform searching and an installation environment for a monitoring camera resistant to a change in characteristics can be provided.

### DESCRIPTION OF DRAWINGS

FIG. 1 is a view illustrating an image monitoring system according to an embodiment of the present invention.

FIG. 2 is a block diagram of an image monitoring device according to an embodiment of the present invention.

FIGS. 3(a) and 3(b) are views illustrating structures of image data and meta data according to an embodiment of the present invention.

FIG. 4 is a view illustrating a structure of a characteristic information table according to an embodiment of the present invention.

FIG. 5 is a flow chart illustrating a process of searching an object according to an embodiment of the present invention.

FIG. 6 is a view illustrating an object search screen according to an embodiment of the present invention.

FIG. 7 is a flow chart illustrating a process of searching an object according to an embodiment of the present invention.

FIGS. 8 and 9 are flow charts illustrating an object search screen according to an embodiment of the present invention, respectively.

FIG. 10 is a flow chart illustrating a process of searching an object according to an embodiment of the present invention.

FIG. 11 is a view illustrating an object search screen according to an embodiment of the present invention.

FIG. 12 is a flow chart illustrating a process of searching an object according to an embodiment of the present invention.

FIG. 13 is a view illustrating an object search screen according to an embodiment of the present invention.

### BEST MODES

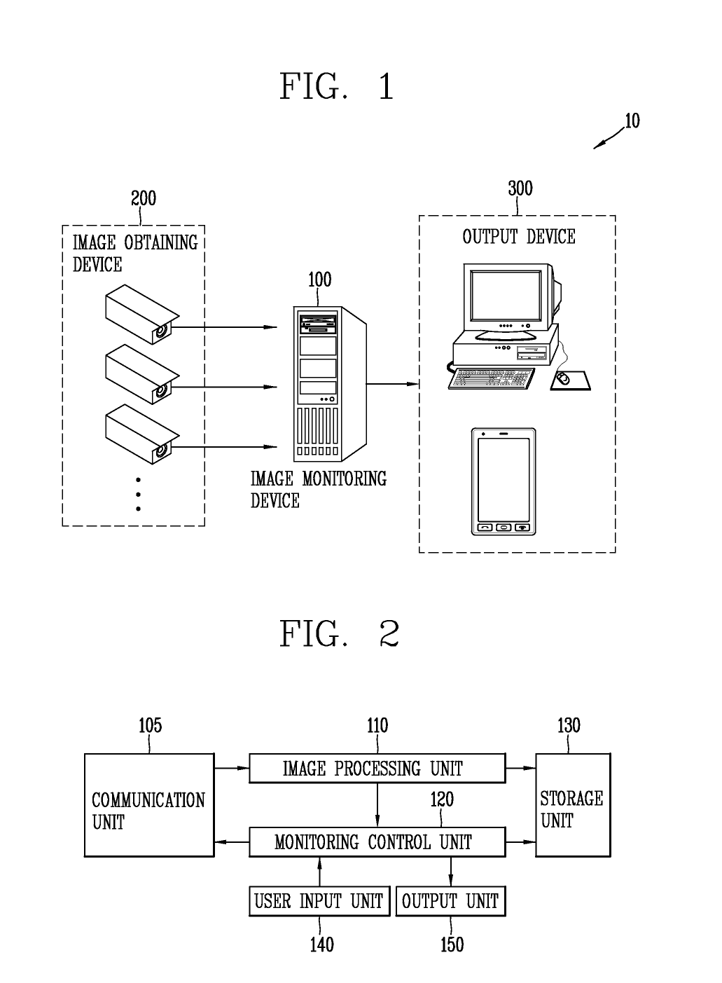

Hereinafter, an image monitoring device and a method for searching an object thereof according to according to embodiments of the present invention will be described with reference to FIGS. 1 through 13.

Definition

A term ‘object’ described in the present disclosure refers to a person, a thing or the like, as a monitoring target in a monitored image. For example, a person or a thing determined to move may be an object.

Also, a term ‘event’ described in the present disclosure refers to an event or facts that may occur in a monitored image. Also, a term ‘monitoring event’ refers to an event which is set for effectively achieving a monitoring purpose by the user.

Description of Image Monitoring System

FIG. 1 is a view illustrating an image monitoring system according to an embodiment of the present invention. An image monitoring system 10 according to an embodiment of the present invention obtains a monitored image through one or more image obtaining devices 200, processing and analyzing the obtained monitored images, and provides the processing and analysis results to a user through an output device 300. The image monitoring system 10 may include an image monitoring device, the image obtaining device 200, and the output device 300.

The image monitoring device 100 analyzes an image obtained through the image obtaining device 200 to generate a compressed image and meta data. Also, the image monitoring device 100 searches meta data for detecting an occurrence of a monitoring event set in a monitored image, and when an occurrence of the monitoring event is detected, the image monitoring device 100 outputs information regarding the detected occurrence of the monitoring event to the output device 300.

In an embodiment, information regarding the detected occurrence of the monitoring event may include a warning message. Also, the meta data may include an ID of an object, a type (e.g., a person, a stuff, or the like) of the object, a time stamp, a current location of the image obtaining device 200, a previous location of the image obtaining device 200, direction data, and the like.

The image obtaining device 200 obtains a monitored image in a monitored environment. The image obtaining device 200 may include a camera (e.g., an optical sensor, a still camera, an analog image camera, a digital image camera, and the like).

The output device 300 may output the processing and analysis results of the monitored image received from the image monitoring device 100 and the information regarding the occurrence of the monitoring event detected from the monitored image. The output device 300 may be a terminal, a network computer, a wireless device (e.g., a PDA), a wireless phone, an information home appliance, a work station, a mini-computer, a main frame computer, a multi-purpose computer, a hardware device dedicated to the image monitoring system 10, or the like.

In an embodiment, a user may remotely receive the processing and analysis results of the monitored image by the output device 300 having a text, messaging, and image function. Also, the user may receive a warning message generated by the image monitoring device 100 by the output device 300. In an embodiment, the warning message may include an image.

Also, the output device 300 may sound an alarm on the basis of the warning message. Alternatively, the output device 300 may transmit a text message by using a previously registered phone number, output a previously stored voice by dialing the phone number, or converting previously stored text into voice and outputting the same, to inform the user that the monitoring event has occurred. The conversion of text into voice may be performed by using a text-to-speech (TTS) technique. Alternatively, the output device 300 may flicker a monitoring item corresponding to a region in which the monitoring event has occurred, to allow the user easily recognize where the monitoring event has occurred.

In this manner, when the image monitoring system 10 sets a monitoring event, and when the monitoring event occurs, the image monitoring system 10 informs the user accordingly. Thus, although the monitoring region is wide, the user can easily do monitoring activities. Also, the image monitoring system 10 may store a monitored image when a pre-set monitoring event occurs, rather than storing all the monitored images. However, even in the case in which a monitoring event is set, the image monitoring system 10 may store a monitored image although a monitoring event does not occur (i.e., regardless of whether or not a monitoring event occurs.

Description of Image Monitoring Device

FIG. 2 is a block diagram of an image monitoring device according to an embodiment of the present invention. The image monitoring device 100 according to an embodiment of the present invention includes a communication unit 105, an image processing unit 110, a monitoring control unit 120, and a storage unit 130.

In order to allow the image monitoring device 100 to communicate with the image obtaining device 200 and/or the output device 300, the communication unit 105 may perform modulation/demodulation and coding/decoding operation on signals transmitted and received to and from the image obtaining device 200 and/or the output device 300. The communication unit 105 may transmit and receive image signals or data to and from the image obtaining device 200 and/or the output device 300 through various communication paths such as a local area network (LAN), a wide area network (WAN, e.g., T1, T3, 56 kb, X.25, ISDM, Frame-Relay, ATM), a wireless network (802.11, Bluetooth™, or the like), universal serial bus (USB), an IEEE 1394 (FireWire), or the like.

The image processing unit 110 analyzes an image obtained from the image obtaining device 200 and generates compressed image data and meta data. The image processing unit 110 stores the generated image data in the storage unit 130, and outputs the meta data to the monitoring control unit 120.

In order to detect an occurrence of a monitoring event set in a monitored image, the monitoring control unit 120 may search the meta data received from the image processing unit 110, and when an occurrence of a monitoring event is detected, the monitoring control unit 120 outputs information regarding the detected occurrence of a monitoring event to the output device 300. Also, the monitoring control unit 120 stores the meta data and the information regarding the detected occurrence of the monitoring event in the storage unit 130.

The storage unit 130 stores an objected image through the image obtaining device 200. The storage unit 130 includes a video cassette recorder (VCR), a digital video recorder (VDR), a redundant array of independent disk (RAID) array, a universal serial bus (USB) hard drive, an optical disk recorder, a flash storage device, an image analyzing device, a multi-purpose computer, a multi-dimensional imaging device, a deinterlacer, a scaler, and/or a processing and storing element for storing and/or processing an image.

The monitored image may be obtained in various analog and/or digital formats. For example, the monitored image may include a non-compressed digital signal using an NTSC (Nation Television System Committee), PAL (Phase Alternating Line), SECAM (Sequential Color with Memory), DVI (Digital Video/visual Interactive), or HDMI (High-Definition Multimedia Interface) connection, and/or a digital signal compressed on the basis of a codec format (e.g., MPEG, MPEG2, MPEG4, or H.264).

Also, the storage unit 130 may store meta data and information regarding a detected occurrence of monitoring event under the control of the monitoring control unit 120.

Meanwhile, the image monitoring device 100 may further include: a user input unit 140 and an output unit 150.

The user input unit 140 may receive an input command applied by the user to control an operation of the image monitoring device 100, and delivers the received command to the monitoring control unit 120 to allow the monitoring control unit 120 to operate according to the command. The user input unit 140 may include a key pad, a dome switch, a touch pad (e.g., static pressure/capacitance), a jog wheel, a jog switch, and the like.

The output unit 150 serves to output an image signal or an alarm signal. The output unit 150 may include a display unit (not shown) outputting the processing and analysis results of a monitored image in the image monitoring device 100 and information regarding a detected occurrence of a monitoring event, an audio output module (not shown), and an alarm unit (not shown) that sounds an alarm on the basis of an alarm message generated by the monitoring control unit 120.

According to an embodiment of the present invention, the monitoring control unit 120 detects an object by frames in the monitored image obtained by the image obtaining device 200. Also, the monitoring control unit 120 calculates a characteristic value of the detected object, and records identification information of frames in which the object was detected, such that the identification information of the frames corresponds to the calculated characteristic value of the object. Also, the monitoring control unit 120 accumulatively records a number of times of detecting the object having the calculated characteristic value in the meta data. The meta data recorded in this manner includes the number of times of detecting the object having a unique characteristic value from the monitored image so far and identification information of the frames in which the object having the unique characteristic value was detected. The monitoring control unit 120 stores the meta data in the storage unit 130.

The monitoring control unit 120 displays a characteristic value of an object detected from a monitored image stored in the storage unit 130 and a detection frequency of the object having the characteristic value on a first region of the display unit. The monitoring control unit 120 reads the number of times of detecting each object having a unique characteristic value from the meta data stored in the storage unit 130. Also, the monitoring control unit 120 generates a detection frequency of each object having a unique characteristic value by normalizing or regularizing the read number of times of detection. The monitoring control unit 120 displays the generated detection frequencies according to respective unique characteristic values of the respective objects on the display unit. In this case, the detection frequencies of the respective objects having a unique characteristic value may be displayed as a graph.

Here, the detection frequency is a value obtained by normalizing the number of times of detection. For example, when an object having a first characteristic value is detected from a monitored image fifty times and an object having a second characteristic value is detected a hundred times, a detection frequency of the object having the first characteristic value is 1 as a value obtained by dividing the number of times of detection by 50 and a detection frequency of the object having the second characteristic value is 2 as a value obtained by dividing the number of times of detection by 50.

The monitoring control unit 120 may search a frame in which an object having a characteristic value selected from among characteristic values displayed on the first region of the display unit is detected from the monitored image stored in the storage unit 130. The monitoring control unit 120 receives an input of selecting one or more of the characteristic values displayed on the first region from the user through the user input unit 140. The monitoring control unit 120 reads identification information of the frame in which the object having the selected characteristic value was detected, from the meta data stored in the storage unit 130.

The monitoring control unit 120 may display the searched frame in a second region of the display unit. Namely, the monitoring control unit 120 extracts a frame corresponding to the identification information of the frame read from the meta data, from the image data stored in the storage unit 130. The monitoring control unit 120 may display the extracted frame on the second region of the display unit.

Here, the frame displayed on the second region may be at least one or more frames, and in this case, the at least one or more frames may be thumbnail images representing an array of images displayed until when the object moves out of the monitored image after the object was detected from the monitored image. Also, when one or more of the thumbnail images displayed on the second region is/are selected, an array of images representing the selected thumbnail images may be displayed.

Also, the frame displayed on the second region may be a frame selected from the searched frames. When the searched frame is a plurality of temporally continued frames, a frame distinctly expressing the characteristics of the object may be selected as a frame to be displayed on the second region. The frame distinctly expressing the characteristics of the object may be a frame having the highest sharpness with respect to the object.

Structure of Image Data and Meta Data

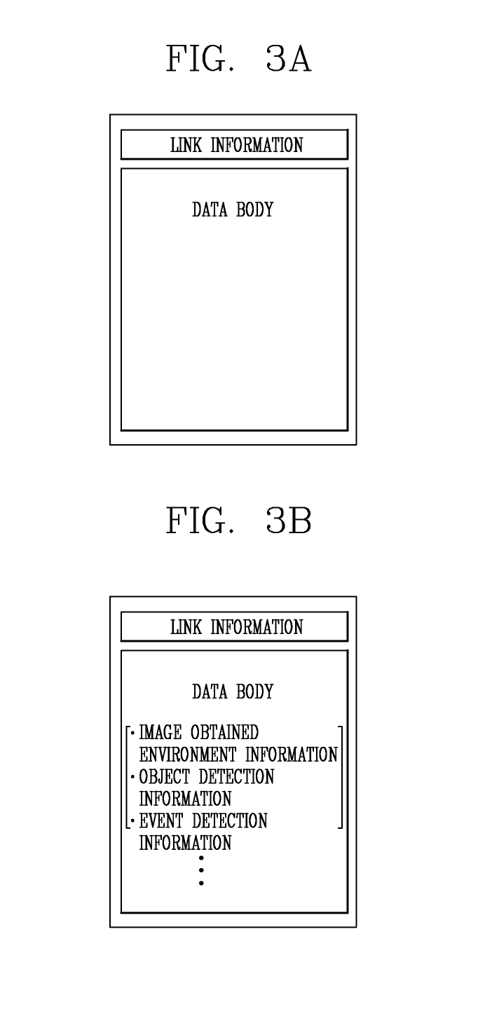

FIGS. 3(a) and 3(b) are views illustrating structures of image data and meta data according to an embodiment of the present invention.

Image data and meta data include link information and a data body, respectively. The data body of the image data is data of a monitored image. Also, data body of meta data includes information indicating a monitoring target and attribute information defining a describing method with respect to the information indicating a monitoring target. Link information includes relevant information indicating relevancy between image data and meta data, and attribute information defining a description method with respect to content of the relevant information.

Relevant information uses, for example, a time stamp or a sequence number for specifying image data. The time stamp indicates information (time information) indicating a time at which image data was generated. Also, the sequence number refers to information (sequence information) indicating a generation sequence of contents data. When there are a plurality of monitored images having the same time stamp, a generation sequence of the image data having the same time stamp may be identified. Also, the relevant information may include information (e.g., a name of a manufacturer, a name of type, a serial number, or the like) for specifying the image obtaining device.

In order to describe the link information and/or meta data body, a markup language defined to describe information exchanged in the Web may be used. In this manner, the use of mark-up language facilitates exchange of information through a network. In addition, when a markup language, e.g., XML used to exchange documents or electronic data, is used. image data and meta data can be easily exchanged. In case that XML is used, for example, XMLSchema is used as attribute information.

According to an embodiment of the present invention, data body of the meta data may include information regarding an environment in which an image is obtained including a location, an angle, or the like, of the image obtaining device, object detection information including an ID, characteristics, and the like, of a detected object, an event detection information including whether a monitoring event set in a monitored image occurs, and the like.

Structure of Characteristic Information Table

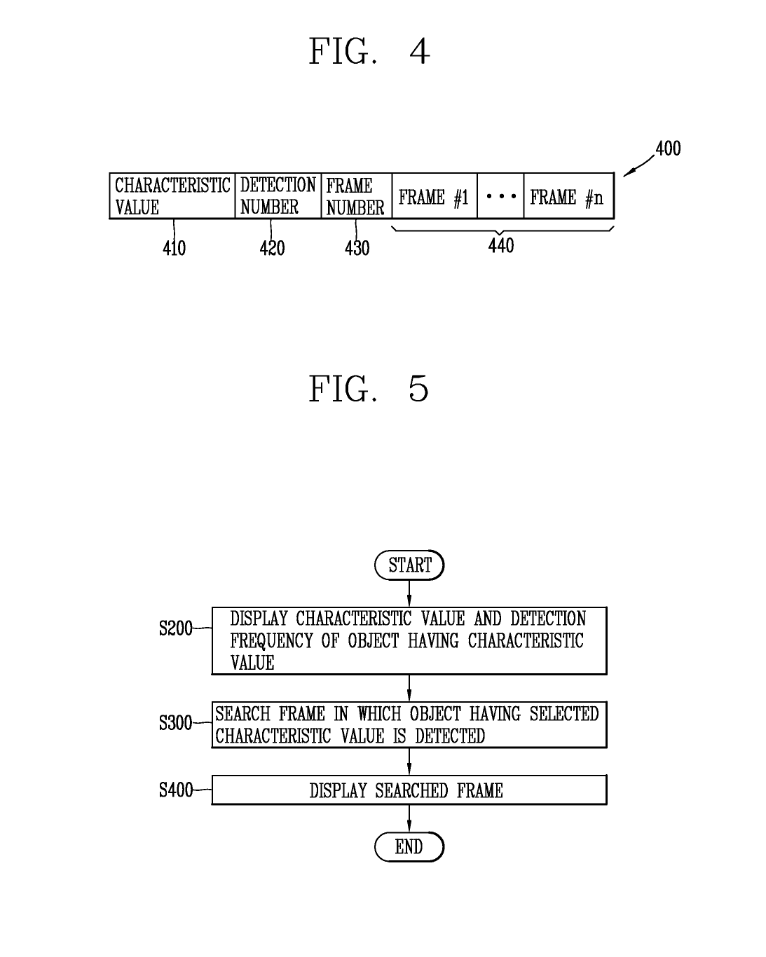

FIG. 4 is a view illustrating a structure of a characteristic information table according to an embodiment of the present invention.

A characteristic information table 400 includes a characteristic value field 410, a detection number field 420, a frame number field 430, and frame identification information field 440. The characteristic value field 410 stores characteristic value of an object.

For example, when characteristics of an object are a size, the characteristic value may be a₁, and a₁ may be determined by Equation 1 shown below:

$${a}_{1} = \frac{p}{m} \qquad [ Equation 1 ]$$

(p is a number of pixels occupied by an object in a monitored image, and m is a natural number)

Also, when a characteristic value is a velocity, a characteristic value may be a₂, and a₂ may be determined by Equation 2 shown below:

$${a}_{2} = \frac{v}{m} \qquad [ Equation 2 ]$$

(v is a velocity of an object and m is a natural number)

Also, when a characteristic value is a color, a characteristic value may be a₃, and a₃ may be determined by Equation 3 shown below:

$${a}_{3} = \frac{c}{m} \qquad [ Equation 3 ]$$

(For example, c is an RGB value of an object and m is a natural number)

Here, m is a factor with respect to precision in searching an object, and as the factor m is reduced, the user can more precisely search an object detected according to characteristic values, and as the factor m is increased, the user may simply search an object detected according to characteristic values.

The detection number field 420 stores the number of times of detecting each object having a unique characteristic value. In a case in which several objects are detected in a single frame, the number corresponding to the several objects may be stored as the number of times of detecting the several objects.

The frame number field 430 is a frame indicating a number of frames in which the object having the corresponding characteristic value is detected, respectively. In a case in which several objects are detected in a single frame, the number of the single frame may be stored as a number of the frame in which objects were detected.

The frame identification information field 440 is a field indicating identification information of frames in which the object having the corresponding characteristic value is detected. It may include identification information regarding a first frame, identification information regarding a second frame, . . . , identification information regarding nth frame (n is a natural number).

In an embodiment of the present invention, the characteristic information table 400 is maintained as described above, based on which the monitoring control unit 120 may determine a characteristic value of an object detected in a monitored image and a detection frequency of the object having the characteristic value. For example, the monitoring control unit 120 may determine a detection frequency of the characteristic value with reference to the detection number field 420. Also, the monitoring control unit 120 may search a frame in which an object having a selected characteristic value was detected, from a monitored image. For example, the monitoring control unit 120 may search a frame in which the object having a selected characteristic value is detected, with reference to the identification information field 440 of frames in the characteristic information table 400.

Description of Process of Researching Object

FIG. 5 is a flow chart illustrating a process of searching an object according to an embodiment of the present invention.

The monitoring control unit 120 displays a characteristic value with respect to an object detected in a monitored image stored in the storage unit 130 and a detection frequency of the object having the characteristic value on the first region of the display unit (S200). The monitoring control unit 120 reads the number of times of detecting each object having a unique characteristic value from the meta data stored in the storage unit 130. Also, the monitoring control unit 120 generates a detection frequency of each object having a unique characteristic value by normalizing (or regularizing) the read number of times of detection. The monitoring control unit 120 displays the generated detection frequencies according to respective characteristic values on the display unit. In this case, the detection frequencies of the respective objects having a unique characteristic value may be displayed as a graph.

The monitoring control unit 120 searches a frame in which an object having a characteristic value selected from among characteristic values displayed on the first region of the display unit is detected from the monitored image stored in the storage unit 130 (S300). The monitoring control unit 120 receives an input of selecting one or more of the characteristic values displayed on the first region from the user through the user input unit 140. The monitoring control unit 120 reads identification information of the frame in which the object having the selected characteristic value was detected, from the meta data stored in the storage unit 130.

Also, the monitoring control unit 120 displays the searched frame in a second region of the display unit. Namely, the monitoring control unit 120 extracts a frame corresponding to the identification information of the frame read from the meta data, from the image data stored in the storage unit 130. The monitoring control unit 120 may display the extracted frame on the second region of the display unit.

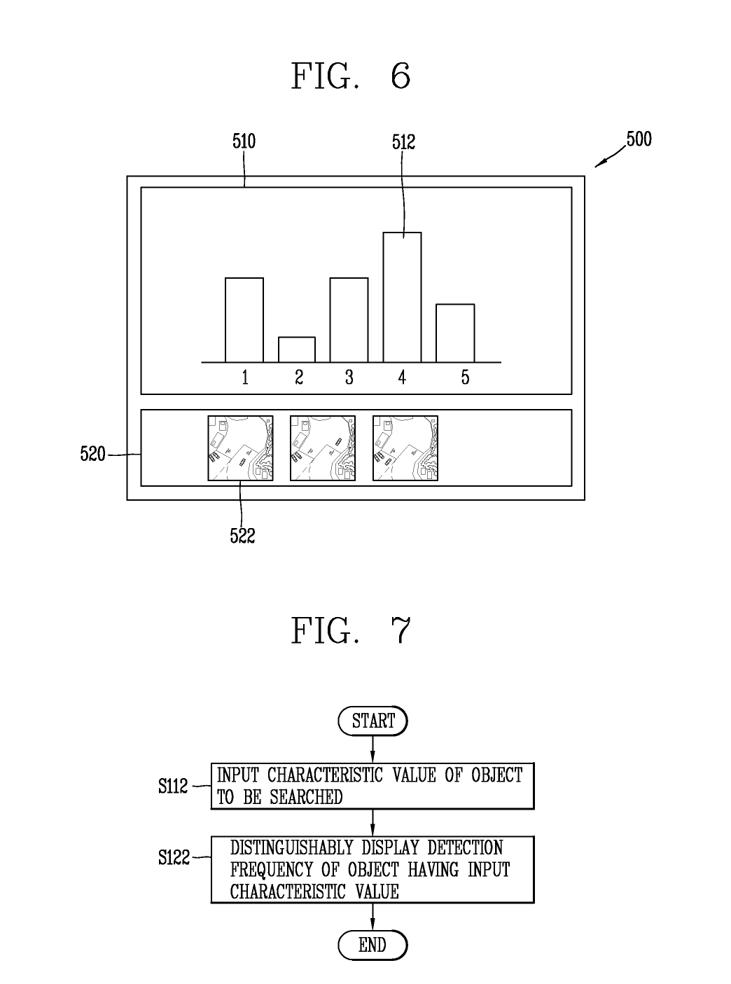

FIG. 6 is a view illustrating an object search screen according to an embodiment of the present invention.

An object search screen 500 includes a detection frequency display region 510 and a frame display region 520. A characteristic value of an object detected in a monitored image and a detection frequency of the object having the characteristic value are displayed in the detection frequency display region 510. A frame in which an object having a characteristic value selected from among characteristic values displayed in the detection frequency display region 510 is displayed in the frame display region 520.

In an embodiment, a characteristic value and a detection frequency may be displayed as a graph in the detection frequency display region 510. In the graph, an x-axis may indicate a characteristic value and y-axis may indicate a detection frequency of the object having the corresponding value (or vice versa).

Among the characteristic value items displayed in the detection frequency display region 510, when a particular characteristic value item 512 is selected, frames in which an object having the characteristic value corresponding to the selected item 512 are displayed in the frame display region 520. Also, when a particular frame 522 is selected from among the frames displayed in the frame display region 520, an image in relation to the selected frame is displayed in the region in which the selected frame is displayed.

FIG. 7 is a flow chart illustrating a process of searching an object according to an embodiment of the present invention.

The monitoring control unit 120 receives a characteristic value of an object to be searched in a monitored image (S112). For example, the monitoring control unit 120 may receive a characteristic value of an object to be searched in the monitored image through the user input unit 140. Meanwhile, the characteristic value of the object to be searched in the monitored image may include a plurality of characteristic values.

Also, the monitoring control unit 120 displays the characteristic value of the object detected from the monitored image and a detection frequency of the object having the characteristic value on the display unit. Here, the monitoring control unit 120 distinguishably displays the detection frequency of the object having the input characteristic value (S114). Meanwhile, in a case in which the characteristic value of the object to be seared in the monitored image includes a plurality of characteristic values, the monitoring control unit 120 may distinguishably display the detection frequency of the object having the characteristic value corresponding between the plurality of characteristic values.

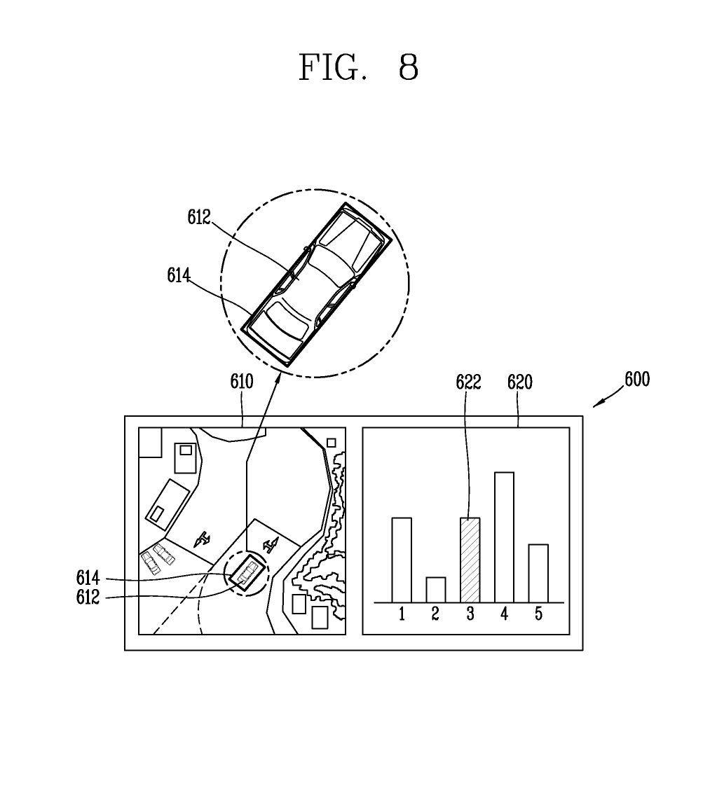

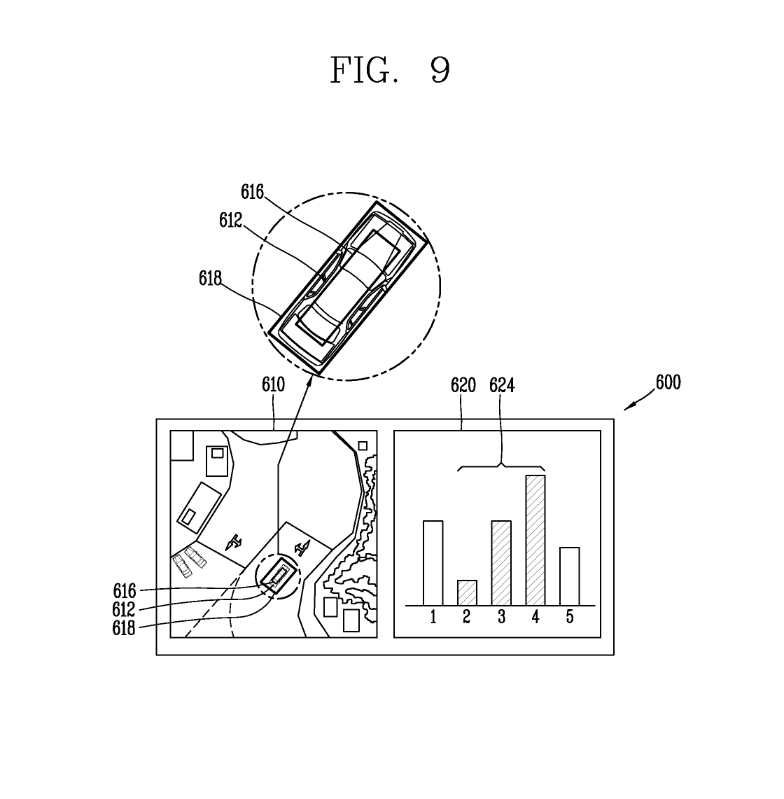

FIGS. 8 and 9 are flow charts illustrating an object search screen according to an embodiment of the present invention, respectively.

Referring to FIG. 8, an object search screen 600 includes a characteristic value input region 610 and a detection frequency display region 620. An interface allowing for inputting of a characteristic value of an object to be searched is provided in the characteristic value input region 610. Also, a monitored image may be displayed in the characteristic value input region 610. The characteristic value of the object detected from the monitored image and a detection frequency of the object having the characteristic value are displayed in the detection frequency display region 620. In this case, the detection frequency corresponding to the input characteristic value input in the characteristic value input region 610 may be distinguishably displayed in the detection frequency display region 620.

In an embodiment, when an object 612 displayed in the monitored image is selected in the characteristic value input region 610, a detection frequency item 622 corresponding to a characteristic value 614 of the selected object is displayed in the detection frequency display region 620 such that it is discriminated from other detection frequency items. For example, the detection frequency item 622 may be discriminated by a shape or color from other detection frequency items.

Referring to FIG. 9, the user may directly input a plurality of characteristic values in the characteristic value input region 610 with reference to the object 612 displayed in the monitored image. For example, with reference to the object 612, the user may generate an item 616 indicating a first characteristic value of the object and an item 618 indicating a second characteristic value of the object. In this case, a detection frequency item 624 corresponding to a characteristic value between the first characteristic value and the second characteristic value may be distinguishably displayed in the detection frequency display region 620.

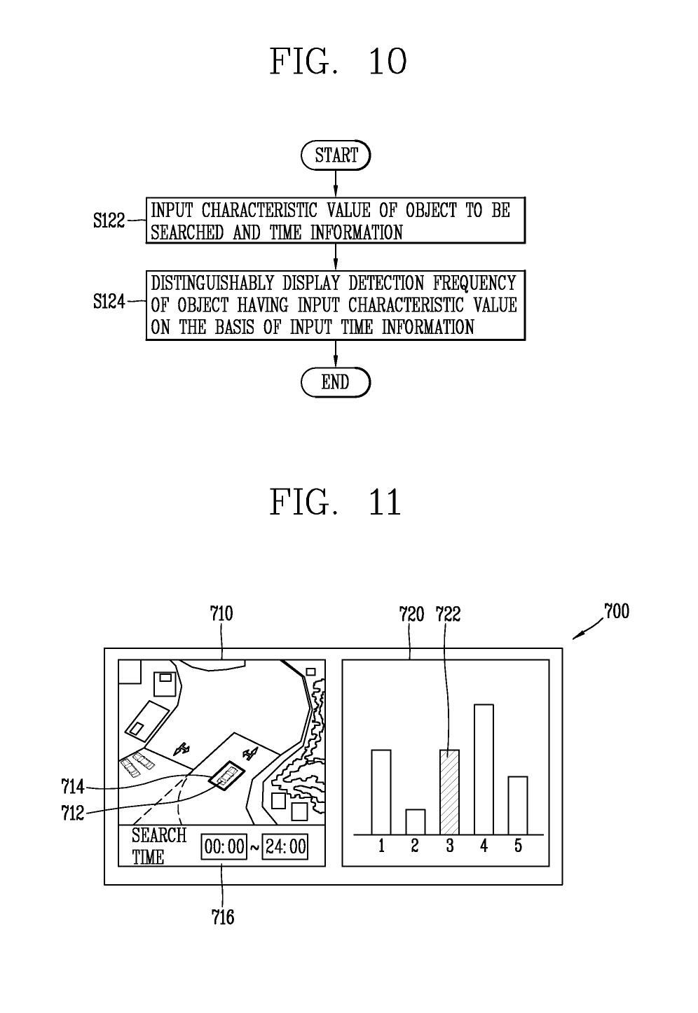

FIG. 10 is a flow chart illustrating a process of searching an object according to an embodiment of the present invention.

The monitoring control unit 120 receives a characteristic value of an object to be searched from a monitored image and information regarding a search time (S122). For example, the monitoring control unit 102 may receive a characteristic value of an object to be searched from a monitored image and information regarding a search time through the user input unit 140.

Also, on the basis of the input time information, the monitoring control unit 120 displays the characteristic value of the object detected from the monitored image and a detection frequency of the object having the characteristic value through the output unit 150. Here, the monitoring control unit 120 displays the detection frequency of the object having the input characteristic value such that it is discriminated or distinguished (S124).

FIG. 11 is a view illustrating an object search screen according to an embodiment of the present invention.

Referring to FIG. 11, an object search screen 700 includes a characteristic value input region 710 and a detection frequency display region 720. An interface allowing for inputting of a characteristic value of an object to be searched is provided in the characteristic value input region 710. Also, a monitored image may be displayed in the characteristic value input region 710. The characteristic value of the object detected from the monitored image and a detection frequency of the object having the characteristic value are displayed in the detection frequency display region 720. In this case, the detection frequency corresponding to the input characteristic value input in the characteristic value input region 710 may be distinguishably displayed in the detection frequency display region 720.

In an embodiment, the characteristic value input region 710 further includes an item for inputting time information. For example, the time information may include a start time and an end time, and a characteristic value of an objected detected from the monitored image and a detection frequency of the object having the characteristic value between the start time and the end time are displayed in the detection frequency display region 720. Also, when the object 712 displayed in the monitored image is selected in the characteristic value input region 710, a detection frequency item 722 corresponding to a characteristic value 714 of the selected object is displayed in the detection frequency display region 720 such that it is discriminated from the other detection frequency items.

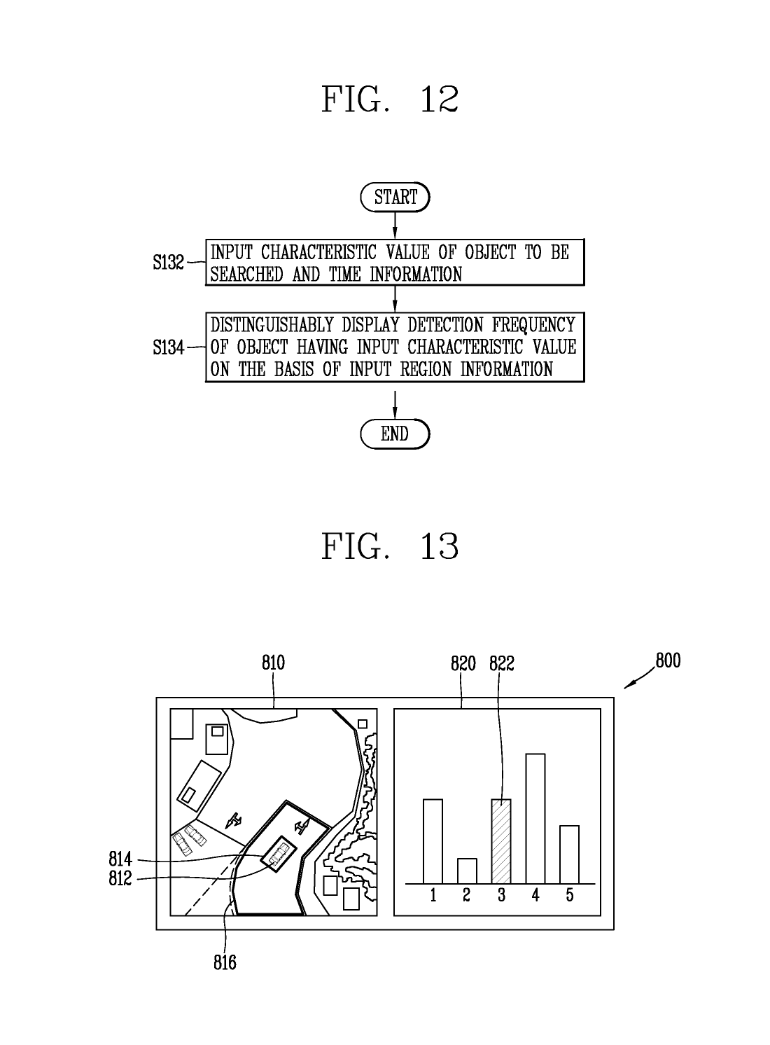

FIG. 12 is a flow chart illustrating a process of searching an object according to an embodiment of the present invention.

The monitoring control unit 120 receives a characteristic value of an object to be searched from a monitored image and information regarding a region to be searched (S132). For example, the monitoring control unit 120 may receive a characteristic value of an object to be searched from a monitored image and information regarding a region to be searched through the user input unit 140.

Also, on the basis of the input region information, the monitoring control unit 120 displays the characteristic value of the object detected from the monitored image and a detection frequency of the object having the characteristic value on the display unit. Here, the monitoring control unit 120 displays distinguishably the detection frequency of the object having the input characteristic value (S134).

FIG. 13 is a view illustrating an object search screen according to an embodiment of the present invention.

Referring to FIG. 13, an object search screen 800 includes a characteristic value input region 810 and a detection frequency display region 820. An interface allowing for inputting of a characteristic value of an object to be searched is provided in the characteristic value input region 810. Also, a monitored image may be displayed in the characteristic value input region 810. The characteristic value of the object detected from the monitored image and a detection frequency of the object having the characteristic value are displayed in the detection frequency display region 820. In this case, the detection frequency corresponding to the input characteristic value input in the characteristic value input region 810 may be distinguishably displayed in the detection frequency display region 820.

In an embodiment, the characteristic value input region 810 provides an interface allowing for inputting of region information. For example, the region information may be a looped curve including a polygonal shape, and the characteristic value of the object detected from the monitored image and a detection frequency of the object having the characteristic value in the input looped curve are displayed in the detection frequency display region 820. Also, when an object 812 displayed in the monitored image is selected in the characteristic value input region 810, a detection frequency item 822 corresponding to a characteristic value 814 of the selected object is displayed in the detection frequency display region 820, such that it is discriminated from the other detection frequency items.

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

1. A method for searching an object by an image monitoring device, the method comprising:
detecting least one of target objects from a monitored image
Displaying, on a first region of a display unit, a characteristic value of the detected object and a detection frequency of the detected object having the characteristic value;
searching at least one of frames, in which an object having a characteristic value selected from characteristic values displayed on the first region is detected, from the monitored image; and
displaying, on a second region of the display unit, the searched frame.

2. The method of claim 1, further comprising:
inputting a characteristic value of an object to be searched from the monitored image, before the displaying of the characteristic value and the detection frequency on the first region,
wherein in the displaying of the characteristic value and the detection frequency on the first region, a detection frequency of an object having the input characteristic value is distinguishably displayed on the first region.

3. The method of claim 2, further comprising:
inputting information regarding a time for searching from the monitored image, before the displaying of the characteristic value and the detection frequency on the first region,
wherein in the displaying of the characteristic value and the detection frequency on the first region, the detection frequency of the object having the input characteristic value is distinguishably displayed on the first region on the basis of the input time information.

4. The method of claim 2, further comprising:
inputting information regarding a region to be searched from the monitored image, before the displaying of the characteristic value and the detection frequency on the first region,
wherein in the displaying of the characteristic value and the detection frequency on the first region, the detection frequency of an object having the input characteristic value is distinguishably displayed on the first region on the basis of the input region information.

5. The method of claim 2, wherein the input characteristic value includes a first characteristic value and a second characteristic value of an object to be searched from the monitored image,
wherein in the displaying of the characteristic value and the detection frequency on the first region, the detection frequency of an object having a value between the first characteristic value and the second characteristic value is distinguishably displayed on the first region.

6. The method of claim 2, further comprising:
displaying the monitored image on a third region of the display unit, before the inputting of the characteristic value,
wherein the inputting of the characteristic value includes calculating a characteristic value of an object selected from objects detected on the third region.

7. The method of claim 1, further comprising:
storing the detection frequency with respect to the characteristic value of an object detected from the monitored image, before the displaying of the characteristic value and the detection frequency on the first region.

8. The method of claim 1, further comprising:
determining the number of times of detecting an object having the characteristic value from the monitored image; and
generating the detection frequency by normalizing the determined number of times of detection.

9. The method of claim 1, wherein the characteristic value includes at least one of a size, a velocity, and a color of an object detected from the monitored image.

10. The method of claim 1, wherein in the displaying of the characteristic value and the detection frequency on the first region, the characteristic value and the detection frequency are displayed as a graph on the first region.

11. The method of claim 1, wherein the displaying of the searched frame on the second region is displaying a frame which is selected from the searched frame.

12. The method of claim 1, wherein the searched frame displayed on the second region is a thumbnail image.

13. The method of claim 12, further comprising:
displaying an image in relation to a thumbnail image selected from the thumbnail images.

14. An image monitoring device comprising:
a controller configured to detect at least one of target objects from a monitored image; and
an output unit configured to display a characteristic value of the detected object and a detection frequency of the detected object having the characteristic value on a first region;
wherein the controller configured to search a frame, in which an object having a characteristic value selected from among characteristic values displayed on the first region is detected, from the monitored image, and control the out the unit to display the searched frame on a second region.

15. The image monitoring device of claim 14, further comprising:
an input unit configured to receive a characteristic value of an object to be searched from the monitored image,
wherein the output unit distinguishably displays, on the first region, a detection frequency of an object having the input characteristic value.
